(19) United States
(12) Patent Application Publication
(10) Pub. No.: US 2004/0048958 A1
(43) Pub. Date: Mar. 11, 2004

(54) High temperature ultra high molecular weight polyethylene

(76) Inventor: David A. Didier, Fort Wayne, IN (US)

Correspondence Address: George Pappas, Pappas Law Office, Suite 300, 919 S. Harrison Street, Fort Wayne, IN, 46802, US

(21) Appl. No.: 10/236,757

(22) Filed: Sep. 6, 2002

(51) Int. Cl. C08K 5/51

(52) U.S. Cl. 524/128; 524/287; 524/349; 524/379; 524/384; 524/387; 524/581

(57) ABSTRACT

A high temperature ultra high molecular weight polyethylene material that has a molecular weight between about 4,000,000 and about 8,000,000. The high temperature UHMW-PE material contains between about 99.0 weight percent and about 99.8 weight percent of ultra high molecular weight polyethylene, and between about 0.2 weight percent and about 1.0 weight percent stabilizer. The stabilizer includes between about 48 weight percent and about 52 weight percent tris (2,4-di-tert-butylphenyl) phosphite, and between about 48.0 weight percent and about 52 weight percent tetrakis [methylene 3-(3,5-di-tert-butyl-4-hydroxyphenyl) propionate] methane.

### FIELD OF THE INVENTION

The present invention pertains to ultra high molecular weight polyethylene (UHMW-PE) materials, and in particular, the invention pertains to ultra high molecular weight polyethylene materials that have applications in high temperature environments.

### BACKGROUND OF THE INVENTION

UHMW polyethylene materials have a wide variety of uses. This is due, at least in part, to these UHMW polyethylene material possessing favorable properties such as high impact strength, a low coefficient of friction, and easy machineability. Furthermore, UHMW polyethylene exhibits good chemical resistance, corrosion resistance, moisture resistance and abrasion resistance.

Exemplary uses for UHMW polyethylene materials include without limitation food processing, food packaging, bulk solids handling, recreation applications, marine uses and water treatment applications. While these uses have been of a wide scope, UHMW polyethylene typically has not been useful in high temperature environments. More specifically, earlier UHMW polyethylene materials (such as TIVAR® 1000 made by Poly Hi Solidur [TIVAR is a registered trademark of Poly Hi Solidur, Inc. with a business address at 1645 Bergstrom Road, Neenah, Wis. 54956])exhibit a maximum operating temperature of about 180 degrees Fahrenheit (about 62 degrees Centigrade). By having a maximum operating temperature of about 180 degrees Fahrenheit (about 62 degrees Centigrade), these earlier UHMW polyethylene materials have not been suitable for certain applications that, except for the high temperatures, would be appropriate applications for UHMW polyethylene material.

It thus becomes very apparent that it would be desirable to provide a UHMW polyethylene that can withstand high temperature environments. For example, these environments may present temperatures of up to about 275 degrees Fahrenheit (135 degrees Centigrade).

It would also be desirable to provide a UHMW polyethylene that can withstand high temperature environments (e.g., up to about 275 degrees Fahrenheit [135 degrees Centigrade]) for a prolonged period of time. Such a prolonged period of time may comprise at least two weeks, and up to seventy-two weeks of exposure at the higher temperature.

### SUMMARY OF THE INVENTION

In one form thereof, the invention is an ultra high molecular weight polyethylene material that comprises between about 99.0 weight percent and about 99.8 weight percent of ultra high molecular weight polyethylene, and between about 0.2 weight percent and about 1.0 weight percent stabilizer. The stabilizer comprises between about 48 weight percent and about 52 weight percent tris (2,4-di-tert-butylphenyl) phosphite, and between about 48.0 weight percent and about 52 weight percent tetrakis [methylene 3-(3,5-di-tert-butyl-4-hydroxyphenyl) propionate] methane.

In yet another form thereof, the invention is a high temperature stabilized ultra high molecular weight polyethylene material that maintains its Izod impact strength during exposure for up to about seventy-two weeks at a temperature of about 135 degrees Centigrade. The high temperature stabilized UHMW-PE material contains between about 99.0 weight percent and about 99.8 weight percent of ultra high molecular weight polyethylene having a molecular weight equal to about 4,000,000 to about 8,000,000, and between about 0.2 weight percent and about 1.0 weight percent stabilizer. The stabilizer comprises between about 48 weight percent and about 52 weight percent of a phosphite antioxidant selected from the group consisting of tris (2,4-di-tert-butylphenyl) phosphite. The stabilizer further contains between about 48.0 weight percent and about 52 weight percent of a hindered phenol antioxidant selected from the group consisting of tetrakis [methylene 3-(3,5-di-tert-butyl-4-hydroxyphenyl) propionate] methane.

In still another form thereof, the invention is a high temperature stabilized ultra high molecular weight polyethylene material suitable for exposure for up to about seventy-two weeks at a temperature of about 135 degrees Centigrade. The material comprises between about 99.0 weight percent and about 99.8 weight percent of ultra high molecular weight polyethylene having a molecular weight equal to about 4,000,000 to about 8,000,000, and between about 0.2 weight percent and about 1.0 weight percent stabilizer. The stabilizer comprises between about 48 weight percent and about 52 weight percent of a phosphite antioxidant selected from the group consisting of tris (2,4-di-tert-butylphenyl) phosphite. The stabilizer further contains between about 48.0 weight percent and about 52 weight percent of a hindered phenol antioxidant selected from the group consisting of tetrakis [methylene 3-(3,5-di-tert-butyl-4-hydroxyphenyl) propionate] methane. The material maintained its Izod impact strength and Abrasion Index during exposure for up to about seventy-two weeks at a temperature of about 135 degrees Centigrade. The material increasing its tensile strength during exposure for up to about seventy-two weeks at a temperature of about 135 degrees Centigrade.

In still another form thereof, the invention is a method of making a high temperature stabilized ultra high molecular weight polyethylene material suitable for exposure for up to about seventy-two weeks at a temperature of about 135 degrees Centigrade, the steps comprising: mixing at a first speed a powder of a ultra high molecular weight polyethylene having a molecular weight equal to between about 4,000,000 and about 8,000,000; supplying a heat stabilization component to the ultra high molecular weight polyethylene powder during the mixing thereof wherein the heat stabilization component comprises between about 48 weight percent and about 52 weight percent of a phosphite antioxidant selected from the group consisting of tris (2,4-di-tert-butylphenyl) phosphite, and between about 48.0 weight percent and about 52 weight percent of a hindered phenol antioxidant selected from the group consisting of tetrakis [methylene 3-(3,5-di-tert-butyl-4-hydroxyphenyl) propionate] methane; continuing the mixing at the first speed of the combination of the ultra high molecular weight polyethylene and the heat stabilization component; mixing the combination of the ultra high molecular weight polyethylene and the heat stabilization component at a second speed wherein the second speed is greater than the first speed; and forming the mixture of the ultra high molecular weight polyethylene and the heat stabilization component into a desired shape.

### BRIEF DESCRIPTION OF THE DRAWINGS

The following is a brief description of the drawings that form a part of this patent application:

FIG. 1 is a graph with the tensile strength in megapascals (MPa) on the vertical axis and the number of weeks that the material of the invention [dashed line] and prior art material (i.e., TIVAR® 1000) [solid line] were exposed at a temperature equal to about 275 degrees Fahrenheit (135 degrees Centigrade) along the horizontal axis;

FIG. 2 is a graph with the change in Izod impact strength in kilo-joules per square meter (kJ/m²) on the vertical axis and the number of weeks that the material of the invention [dashed line] and prior art material (i.e., TIVAR® 1000) [solid line] were exposed at a temperature equal to about 275 degrees Fahrenheit (135 degrees Centigrade) along the horizontal axis; and

FIG. 3 is a graph with the abrasion index (AI) from sand wheel testing on the vertical axis and the number of weeks that the material of the invention [dashed line] and prior art material (TIVAR® 1000) [solid line] were exposed at a temperature equal to about 275 degrees Fahrenheit (135 degrees Centigrade) along the horizontal axis.

### DETAILED DESCRIPTION OF THE INVENTION

Generally speaking, the invention is an ultra high molecular weight polyethylene (UHMW-PE) material that has excellent properties for use in high temperature applications, i.e., a high temperature UHMW-PE material. These high temperature applications include industries such as baking, conveyor manufacturing, food processing and packaging, meat and poultry processing and pet food manufacturing. Specific applications include in conveyor systems or other equipment that is frequently exposed to chemical washdowns in such industries as poultry/meat processing and packaging. High temperature UHMW-PE material can also be used in applications such as, for example, wear strips for spiral conveyors in the baking industry, drag conveyor flights for moving bulk materials (corn) in grain elevators, and wear strips for conveyor dryers in drying and dehydrating systems.

The high temperature UHMW-PE material of the invention is suitable for these applications because it is able to withstand high temperatures up to about 275 degrees Fahrenheit (135 degrees Centigrade) for prolonged periods of time without degradation (or significant degradation) of certain properties of the high temperature UHMW-PE. This is in contrast to earlier UHMW-PE material (e.g., TIVAR® 1000) that possesses a maximum operating temperature equal to about 180 degrees Fahrenheit (62 degrees Centigrade) so that when it is subjected to high temperatures (e.g., 275 degrees Fahrenheit [135 degrees Centigrade]) properties diminish.

Referring to the production of the high temperature UHMW-PE, very generally, unstabilized UHMW-PE material having a molecular weight equal to about 4,000,000 to about 8,000,000 is introduced into a mixing apparatus (e.g. a commercial mixer or extruder, and most preferably, a high intensity mixer) in the form of a powder. While the mixer is running at a speed of about 675 revolutions per minute (rpm), the heat stabilization component is introduced into the unstabilized UHMW-PE powder mixture as it is being mixed. Pigment is then added to the mixture of UHMW-PE and the heat stabilization component, and then mixed at a speed of about 1785 rpm for about 60 seconds. This mixture is subsequently removed from the mixer and formed into the desired shape. Typically, the high temperature UHMW-PE is in the form of sheets, rods, and tubes.

Referring to the starting composition for the high temperature UHMW-PE, the content of the-mixture is between about 99.0 weight percent and about 99.8 weight percent unstabilized UHMW-PE powder and between about 0.2 weight percent and about 1 weight percent of the heat stabilizer component. More preferably, the content of the mixture is between about 99.2 weight percent and about 99.6 weight percent unstabilized UHMW-PE powder and between about 0.4 weight percent and about 0.8 weight percent of the heat stabilizer component. Most preferably, the content of the mixture is about 99.5 weight percent unstabilized UHMW-PE powder and about 0.5 weight percent of the heat stabilizer component.

It is preferred that the heat stabilizer component is in the form of a liquid. When the heat stabilizer is in the form of a liquid, it can coat the unstabilized UHMW-PE powder. A preferred heat stabilization component is B225 that is available from Ciba Geigy. The Ciba Geigy B225 liquid heat stabilizer component comprises a combination of a phenolic antioxidant material and a phosphite antioxidant material.

As an alternative to the liquid heat stabilizer, this component may be in the form of powder. In this case, one preferred powder heat stabilizer component is identified as CHINOX™ B225 which is available from Chitec Chemical Co., Ltd of Taiwan, Republic of China. According to data sheets from Chitec Chemical, the term “CHINOX” is a trademark of Chitec Chemical Co., Ltd. The CHINOX™ B225 powder is a combination of between about 48.0 weight percent to about 52.0 weight percent of a phosphate antioxidant identified as CHINOX™ 168 and between about 48.0 weight percent and about 52.0 weight percent of a hindered phenol antioxidant identified as CHINOXT™ 1010.

The properties of CHINOX™ B225 taken from a data sheet of Chitec Chemical Co., Ltd. are set forth below in Table 1.

TABLE 1
Properties of CHINOX ™ B225 Anti-Oxidant

| Property | Description |
|---|---|
| CAS Name | 50% Chinox 168; 50% Chinox 1010 |
| Appearance | White crystalline powder |
| Bulk Density | 530-630 kg/m³ @ 20° C. |
| Vapor Pressure | <0.01 Pa @ 20° C. |
| Appearance | White powder |
| Volatile | 0.5% max. |
| Solubility | Clear solution (lg/10 ml toluene) |
| Transmittance @ 425 nm | 97% min. |
| Transmittance @ 500 nm | 97% min. |
| Content of Chinox 168 | 48.0-52.0% |

Referring to the components of CHINOX™ B225, the CHINOX™ 168 component is a phosphite antioxidant, and more specifically, has the chemical name tris (2,4-di-tert-butylphenyl) phosphite. The chemical structure of CHINOX™ 168 taken from the data sheet of Chitec Chemical is set forth below.

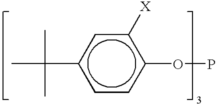

The properties of CHINOX™ 168, which are taken from the data sheet of Chitec Chemical Co., Ltd., are set forth below in Table 2.

TABLE 2
Properties of CHINOX ™ 168

| Property | Description |
|---|---|
| Chemical Name | tris(2,4-di-tert-butylphenyl) |
| | phosphate |
| CAS No. | 31570-04-4 |
| Molecular weight | 647 |
| Appearance | White crystalline powder |
| Assay | 99% min. |
| Melting point | 180-186° C. |
| Ash content | 0.1% max. |
| Volatiles content | 0.3% max. |
| Acid value (mg KOH/g) | 0.2% max. |
| 2,4-DTBP Content | 0.1% max. |
| Transmittance @ 425 nm | 97% min. |
| Transmittance @ 500 nm | 98% min. |

The other component of CHINOX™ B225 is CHINOX™ 1010, which is a hindered phenol antioxidant. More specifically, this hindered phenol antioxidant is tetrakis [methylene 3-(3,5-di-tert-butyl-4 hydroxyphenyl) propionate] methane. The chemical structure of CHINOX™ 1010 is set forth below.

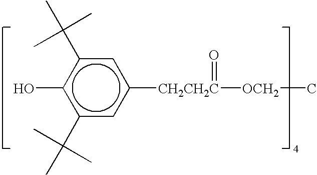

The properties of CHINOX™ 1010 as taken from the data sheet from Chitec Chemical Co., Ltd. are set forth below in Table 3.

TABLE 3
Properties of CHINOX ™ 1010

| Property | Description |
|---|---|
| Chemical Name | tetrakis [methylene 3-(3,5-di- |
| | tert-butyl-4 hydroxyphenyl) |
| | propionate] methane |
| CAS No. | 6683-19-8 |
| Molecular Weight | 1178 |
| Appearance | White powder or free-flowing |
| | granules |
| Assay | 98% minimum |
| Melting Point | 110-125° C. |
| Ash Content | 0.1% Maximum |
| Volatiles Content | 0.5% Maximum |
| Solubility | Clear Solution |
| Transmittance @ 425 nm | 97% Minimum |
| Transmittance @ 500 nm | 98% Minimum |

As another alternative to the CHINOX™ B225, applicant contemplates using anti-oxidant sold by Ciba Specialty Chemicals Corp. and identified as IRGANOX® B-225 [IRGANOX is a registered trademark of Ciba Specialty Chemicals Corp.]. IRGANOX® B-225 is a 1:1 mixture of IRGAFOS® 168 [which is tris (2,4-di-tert-butylphenyl)phosphate and IRGANOX® 1010 [which is pentaerythritol tetrakis 3-(3,5-di-tert-butly-4hydroxyphenyl) propionate]. IRGAFOS is a registered trademark of Ciba Specialty Chemicals Corp.

The formula for IRGANOX® 1010 is set forth below:

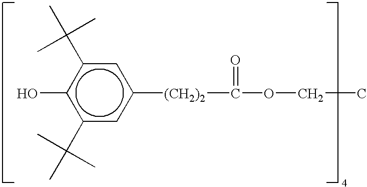

According to a description found in U.S. Pat. No. 5,846,656 to Dunski, the combination of IRGAFOS® 168 and IRGANOX® 1010 is shown and described in U.S. Pat. No. 4,187,212 to Zinke et al.

The preferred ultra high temperature UHMW-PE has the following composition: between about 99.2 weight percent to about 99.6 weight percent unstabilized UHMW-PE that has a molecular weight equal to about 4,000,000 to about 8,000,000, and between about 0.4 weight percent to about 0.8 weight percent of a heat stabilizer component comprising CHINOX B225. This heat stabilizer component (CHINOX B225) comprises about 48 weight percent of CHINOX 1010 and about 52 weight percent CHINOX 168. The preferred high temperature UHMW-PE material has the following properties as set forth in Table 4.

TABLE 4
Properties of High Temperature UHMW-PE Material

| | | | | English | English |
|---|---|---|---|---|---|
| Property | Method | SI Unit | SI Value | Unit | Value |
| Yield Point | ASTM D- | MPa | 19.8 | Psi | 2873 |
| | 638 | | | | |
| Elongation | ASTM D- | % | 200 | % | 200 |
| at Break | 638 | | | | |
| Tensile | ASTM D- | MPa | 52.5 | Psi | 7618 |
| Break | 638 | | | | |
| Izod Impact | ASTM D- | kJ/m² | 60 | Ft- | 29 |
| | 4020 | | | lbs/in² | |
| Static | ASTM D- | Unitless | 0.15 | Unitless | 0.15 |
| Friction | 1894 | | | | |
| Dynamic | ASTM D- | Unitless | 0.12 | Unitless | 0.12 |
| Friction | 1894 | | | | |
| Coefficient | ASTM D- | ° C.⁻¹ | 0.0002 | ° F.⁻¹ | 0.00011 |
| of Thermal | 696 | | | | |
| Exp. | | | | | |
| Melt Point | ASTM D- | ° C. | 137-143 | ° F. | 278-289 |
| | 3417 | | | | |
| Maximum | | ° C. | 135 | ° F. | 275 |
| Operating | | | | | |
| Temp. | | | | | |
| Water | ASTM D- | % | Nil | % | nil |
| Absorption | 570 | | | | |

In order to determine the impact of the addition of the heat stabilizer component to the UHMW-PE material, applicant conducted tests to compare certain properties of the high temperature UHMW-PE material with the properties of the earlier UHMW-PE material after the materials had been exposed to high temperatures. Applicant tested samples of the high temperature UHMW-PE material of the invention against a prior art UHMW-PE material. This prior art material was TIVAR® 1000 (a UHMW-PE material sold by Poly Hi Solidur at 2710 American Way, Fort Wayne, Ind. 46809) The properties of the TIVAR® 1000 material are set forth in Table 5 below.

TABLE 5
Properties of TIVAR ® 1000

| | | | SI | English | English |
|---|---|---|---|---|---|
| Property | Method | SI Unit | Value | Unit | Value |
| Yield Point | ASTM D- | MPa | 21 | psi | 3050 |
| | 638 | | | | |
| Elongation | ASTM D- | % | 15 | % | 15 |
| at Yield | 638 | | | | |
| Tensile | ASTM D- | MPa | 40 | psi | 5800 |
| Break | 638 | | | | |
| Izod Impact | ASTM D- | kJ/m² | 70 | Ft- | 34 |
| | 4020 | | | lbs/in² | |
| Static | ASTM D- | Unitless | 0.15 | Unitless | 0.15 |
| Friction | 1894 | | | | |
| Dynamic | ASTM D- | Unitless | 0.12 | Unitless | 0.12 |
| Friction | 1894 | | | | |
| Coefficient | ASTM D- | ° C.⁻¹ | 0.0002 | ° F.⁻¹ | 0.00011 |
| of Thermal | 696 | | | | |
| Exp. | | | | | |
| Melt Point | ASTM D- | ° C. | 137-143 | ° F. | 278-289 |
| | 3417 | | | | |
| Maximum | | ° C. | 62 | ° F. | 180 |
| Operating | | | | | |
| Temp. | | | | | |
| Water | ASTM D- | 5 | nil | % | nil |
| Absorption | 570 | | | | |

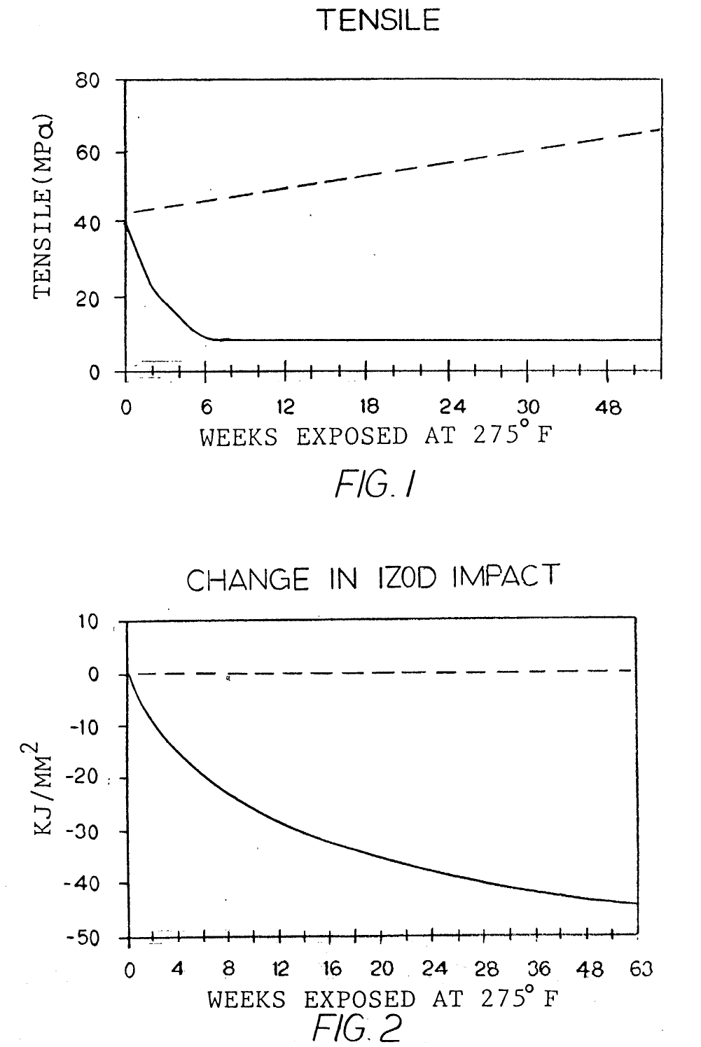

FIG. 1 shows the comparison between the tensile strength of the high temperature UHMW-PE material and the UHMW-PE material wherein these materials were exposed for different times to a temperature of about 275 degrees Fahrenheit (135 degrees Centigrade). The tensile strength of the high temperature UHMW-PE material is shown by the dashed line. The tensile strength of the TIVAR 1000® material (i.e., the UHMW-PE material) is shown by the solid line. The tensile strength was measured according to the method set forth in ASTM D-638. The testing was done at room temperature on samples that had been exposed to the higher temperature for various durations.

FIG. 1 shows the tensile strength as measured in megapascals (MPa) along the vertical axis and the duration (in weeks) the sample was exposed to the high temperature along the horizontal axis. It is apparent from the results as set forth in FIG. 1 that the high temperature UHMW-PE material maintained, and in fact increased, in tensile strength with an increase in the duration of high temperature exposure. This is in contrast to the TIVAR® 1000 material that lost tensile strength early on and maintained a lower level of tensile strength for the duration of the testing. Even though FIG. 1 shows the results for testing for a duration of about fifty-two weeks, the high temperature UHMW-PE material maintained its tensile strength for up to seventy-two weeks.

FIG. 2 shows the comparison between the change in Izod impact strength of the high temperature UHMW-PE material and the UHMW-PE material wherein these materials were exposed for different times to a temperature of about 275 degrees Fahrenheit (135 degrees Centigrade). The change in the Izod impact strength of the high temperature UHMW-PE material is shown by the dashed line. The change in the Izod impact strength of the TIVAR 1000® material (i.e., the UHMW-PE material) is shown by the solid line. The Izod impact strength was measured according to the method set forth in ASTM D-4020. The testing was done at room temperature on samples that had been exposed to the higher temperature for various durations.

FIG. 2 shows the change in the Izod impact strength as measured in kilo-Joules per square meter (kJ/m²) along the vertical axis and the duration (in weeks) the sample was exposed to the high temperature along the horizontal axis. It is apparent from the results as set forth in FIG. 2 that the high temperature UHMW-PE material maintained its impact strength throughout the duration of high temperature exposure. This is in contrast to the TIVAR® 1000 material that continually lost impact strength as the material was subjected to high temperature exposure. Even though FIG. 2 shows the results for testing for a duration of about sixty-three weeks, the high temperature UHMW-PE material maintained its Izod Impact Strength for up to seventy-two weeks.

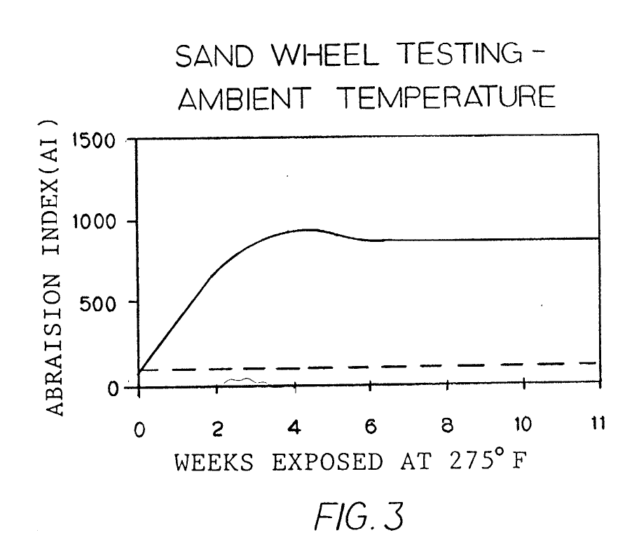

FIG. 3 shows the comparison between the abrasion index of the high temperature UHMW-PE material and the UHMW-PE material wherein these materials were exposed for different times to a temperature of about 275 degrees Fahrenheit (135 degrees Centigrade). The abrasion index is a measure of the ability of the material to resist abrasion. A lower number for the Abrasion Index represents better resistance to abrasion. The Abrasion Index of the high temperature UHMW-PE material is shown by the dashed line. The Abrasion Index of the TIVAR 1000® material (i.e., the UHMW-PE material) is shown by the solid line. The Abrasion Index was determined using a sand wheel test method according to ASTM G-65. The testing was done at room temperature on samples that had been exposed to the higher temperature for various durations.

FIG. 3 shows the Abrasion Index along the vertical axis and the duration (in weeks) the sample was exposed to the high temperature along the horizontal axis. It is apparent from the results as set forth in FIG. 3 that the high temperature UHMW-PE material maintained a low Abrasion Index as compared to the TIVAR® 1000 material wherein the Abrasion Index increased to a point with an increase in the duration of the high temperature exposure. Even though FIG. 3 shows the results for testing for a duration of about eleven weeks, the high temperature UHMW-PE material maintained its low Abrasion Index for up to seventy-two weeks.

The patents, patent applications, and other documents identified herein are hereby incorporated by reference herein.

Other embodiments of the invention will be apparent to those skilled in the art from a consideration of the specification of the practice of the invention disclosed herein. It is intended that the specification and examples be considered as illustrative only, and that the true spirit and scope of the invention being indicated by the following claims.

What is claimed is:

1. A ultra high molecular weight polyethylene material comprising:
between about 99.0 weight percent and about 99.8 weight percent of ultra high molecular weight polyethylene; and
between about 0.2 weight percent and about 1.0 weight percent stabilizer; and
the stabilizer comprises:
between about 48 weight percent and about 52 weight percent tris (2,4-di-tert-butylphenyl) phosphite; and
between about 48.0 weight percent and about 52 weight percent pentaerythritol tetrakis 3-(3,5-di-tert-butyl-4-hydroxyphenyl) propionate.

2. The ultra high molecular weight polyethylene material according to claim 1 comprising between about 99.2 weight percent and about 99.6 weight percent of the ultra high molecular weight polyethylene; and between about 0.4 weight percent and about 0.8 weight percent of the stabilizer.

3. The ultra high molecular weight polyethylene material according to claim 1 comprising about 99.5 weight percent of the ultra high molecular weight polyethylene, and about 0.5 weight percent of the stabilizer.

4. The ultra high molecular weight polyethylene material according to claim 1 wherein the stabilizer is in a liquid form.

5. The ultra high molecular weight polyethylene material according to claim 1 wherein the ultra high molecular weight polyethylene is in a powder form and has a molecular weight equal to between about 4,000,000 and about 8,000,000.

6. The ultra high molecular weight polyethylene material according to claim 5 wherein the stabilizer is a powder form.

7. The ultra high molecular weight polyethylene material according to claim 5 wherein the stabilizer is in a liquid form.

8. The ultra high molecular weight polyethylene material according to claim 1 wherein the material having a melting point between about 137 degrees Centigrade and about 143 degrees Centigrade.

9. A high temperature stabilized ultra high molecular weight polyethylene material that maintains its Izod impact strength during exposure for up to about seventy-two weeks at a temperature of about 135 degrees Centigrade, the material comprising:
between about 99.0 weight percent and about 99.8 weight percent of ultra high molecular weight polyethylene having a molecular weight equal to between about 4,000,000 and about 8,000,000; and
between about 0.2 weight percent and about 1.0 weight percent stabilizer wherein the stabilizer comprises:
between about 48 weight percent and about 52 weight percent of a phosphite antioxidant selected from the group consisting of tris (2,4-di-tert-butylphenyl) phosphite; and
between about 48.0 weight percent and about 52 weight percent of a hindered phenol antioxidant selected from the group consisting of tetrakis [methylene 3-(3,5-di-tert-butyl-4-hydroxyphenyl) propionate methane.

10. The high temperature stabilized ultra high molecular weight polyethylene material according to claim 9 wherein the material has an Izod impact strength equal to between about 50 kJ/meter² and about 70 kJ/meter².

11. The high temperature stabilized ultra high molecular weight polyethylene material according to claim 9 wherein the material has an Izod impact strength equal to between about 55 kJ/meter² and about 65 kJ/meter².

12. The high temperature stabilized ultra high molecular weight polyethylene material according to claim 9 comprising between about 99.2 weight percent and about 99.6 weight percent of the ultra high molecular weight polyethylene; and between about 0.4 weight percent and about 0.8 weight percent of the stabilizer.

13. The high temperature stabilized ultra high molecular weight polyethylene material according to claim 9 comprising about 99.5 weight percent of the ultra high molecular weight polyethylene, and about 0.5 weight percent of the stabilizer.

14. The high temperature stabilized ultra high molecular weight polyethylene material according to claim 9 wherein the ultra high molecular weight polyethylene is in a powder form and has a molecular weight equal to between about 4,000,000 and about 8,000,000.

15. The high temperature stabilized ultra high molecular weight polyethylene material according to claim 14 wherein the stabilizer is a powder form.

16. The high temperature stabilized ultra high molecular weight polyethylene material according to claim 14 wherein the stabilizer is in a liquid form.

17. The high temperature stabilized ultra high molecular weight polyethylene material according to claim 9 wherein the material having a melting point between about 137 degrees Centigrade and about 143 degrees Centigrade.

18. A high temperature stabilized ultra high molecular weight polyethylene material suitable for exposure for up to about seventy-two weeks at a temperature of about 135 degrees Centigrade, the material comprising:
between about 99.0 weight percent and about 99.8 weight percent of ultra high molecular weight polyethylene having a molecular weight equal to between about 4,000,000 and about 8,000,000;
between about 0.2 weight percent and about 1.0 weight percent stabilizer wherein the stabilizer comprises:
between about 48 weight percent and about 52 weight percent of a phosphite antioxidant selected from the group consisting of tris (2,4-di-tert-butylphenyl) phosphite; and
between about 48.0 weight percent and about 52 weight percent of a hindered phenol antioxidant selected from the group consisting of tetrakis [methylene 3-(3,5-di-tert-butyl-4-hydroxyphenyl) propionate] methane;
the material maintaining its Izod impact strength during exposure for up to about seventy-two weeks at a temperature of about 135 degrees Centigrade;
the material increasing its tensile strength during exposure for up to about seventy-two weeks at a temperature of about 135 degrees Centigrade; and
the material maintaining its Abrasion Index during exposure for up to about seventy-two weeks at a temperature of about 135 degrees Centigrade.

19. The high temperature stabilized ultra high molecular weight polyethylene material according to claim 18 comprising between about 99.2 weight percent and about 99.6 weight percent of the ultra high molecular weight polyethylene; and between about 0.4 weight percent and about 0.8 weight percent of the stabilizer.

20. The high temperature stabilized ultra high molecular weight polyethylene material according to claim 18 comprising about 99.5 weight percent of the ultra high molecular weight polyethylene, and about 0.5 weight percent of the stabilizer.

21. The high temperature stabilized ultra high molecular weight polyethylene material according to claim 18 wherein the ultra high molecular weight polyethylene is in a powder form.

22. The high temperature stabilized ultra high molecular weight polyethylene material according to claim 21 wherein the stabilizer is a powder form.

23. The high temperature stabilized ultra high molecular weight polyethylene material according to claim 21 wherein the stabilizer is in a liquid form.

24. The high temperature stabilized ultra high molecular weight polyethylene material according to claim 18 wherein the material having a melting point between about 137 degrees Centigrade and about 143 degrees Centigrade.

25. A method of making a high temperature stabilized ultra high molecular weight polyethylene material suitable for exposure for up to about seventy-two weeks at a temperature of about 135 degrees Centigrade, the steps comprising:
mixing at a first speed a powder of a ultra high molecular weight polyethylene having a molecular weight equal to between about 4,000,000 and about 8,000,000;
supplying a heat stabilization component to the ultra high molecular weight polyethylene powder during the mixing thereof wherein the heat stabilization component comprises between about 48 weight percent and about 52 weight percent of a phosphite antioxidant selected from the group consisting of tris (2,4-di-tert-butylphenyl) phosphite, and between about 48.0 weight percent and about 52 weight percent of a hindered phenol antioxidant selected from the group consisting of tetrakis [methylene 3-(3,5-di-tert-butyl-4-hydroxyphenyl) propionate] methane;
continuing the mixing at the first speed of the combination of the ultra high molecular weight polyethylene and the heat stabilization component;
mixing the combination of the ultra high molecular weight polyethylene and the heat stabilization component at a second speed wherein the second speed is greater than the first speed; and
forming the mixture of the ultra high molecular weight polyethylene and the heat stabilization component into a desired shape.

26. The method according to claim 25 wherein the ultra high molecular weight polyethylene comprises between about 99.0 weight percent and about 99.8 weight percent of the high temperature stabilized ultra high molecular weight polyethylene, and the heat stabilization component comprises between about 0.2 weight percent and about 1.0 weight percent of the high temperature stabilized ultra high molecular weight polyethylene.

27. The method according to claim 25 wherein the high temperature stabilized ultra high molecular weight polyethylene maintains its Izod impact strength during exposure for up to about seventy two weeks at a temperature of about 135 degrees Centigrade.

28. The method according to claim 25 wherein the high temperature stabilized ultra high molecular weight polyethylene maintains its tensile strength during exposure for up to about seventy two weeks at a temperature of about 135 degrees Centigrade.

29. The method according to claim 25 wherein the high temperature stabilized ultra high molecular weight polyethylene maintains its Abrasion Index during exposure for up to about seventy two weeks at a temperature of about 135 degrees Centigrade.

30. The method according to claim 25 wherein the high temperature stabilized ultra high molecular weight polyethylene material comprises between about 99.2 weight percent and about 99.6 weight percent of the ultra high molecular weight polyethylene; and between about 0.4 weight percent and about 0.8 weight percent of the heat stabilization component.

31. The method according to claim 25 wherein the high temperature stabilized ultra high molecular weight polyethylene material comprises about 99.5 weight percent of the ultra high molecular weight polyethylene, and about 0.5 weight percent of the heat stabilization component.

32. The method according to claim 25 wherein the heat stabilization component is in a powder form.

33. The method according to claim 25 wherein the heat stabilization component is in a liquid form.

34. The method according to claim 25 wherein the first speed is equal to about 675 revolutions per minute.

35. The method according to claim 25 wherein the second speed is equal to about 1785 revolutions per minute.

36. The method according to claim 25 wherein the second speed is equal to between about 2.2 and about 3 times the first speed.

37. The method according to claim 25 wherein the second speed is equal to about 2.6 times the first speed.
